(19) United States
(12) Patent Application Publication
(10) Pub. No.: US 2023/0162128 A1
(43) Pub. Date: May 25, 2023

(54) SYSTEMS AND METHODS FOR OPTIMIZING THE DELIVERY OF A PACKAGE

(71) Applicant: HERE GLOBAL B.V., Eindhoven (NL)

(72) Inventor: JEROME BEAUREPAIRE, BERLIN (DE)

(21) Appl. No.: 17/534,992

(22) Filed: Nov. 24, 2021

(51) Int. Cl. G06Q 10/08

(52) U.S. Cl. CPC G06Q 10/0833; G06Q 10/0836

(57) ABSTRACT

Systems and methods for optimizing the delivery of a package are provided. For example, a method for optimizing the delivery of a package includes receiving information about a package scheduled for delivery at a first location. The package corresponds to a recipient associated with the first location. The method also includes analyzing mobility data of a neighbor at a second location. The method also includes based on the analysis, selecting the neighbor as an authorized recipient of the package.

### TECHNICAL FIELD

The present disclosure relates generally to delivery of packages, and more specifically to systems and methods for optimizing the delivery of a package.

### BACKGROUND

When a package being transported by a person, autonomous ground vehicle, drone, etc., reaches its destination and there is no one available to receive the package, any number of problems may ensue. In some instances, the package might be stolen, damaged, or destroyed. In some cases where there is no interaction between a person delivering a package and a person receiving the package, the package is placed in an area without consideration of any factors. In some locations, this manner of delivering packages is not sustainable. Crimes of opportunity, insurance claims, loss of time, logistics planning, etc., are some of the problems that may result from the lack of optimizing the delivery of a package.

### BRIEF SUMMARY

The present disclosure overcomes the shortcomings of prior technologies. In particular, a novel approach for optimizing the delivery of a package is provided, as detailed below.

In accordance with an aspect of the disclosure, a method for optimizing the delivery of a package is provided. The method includes receiving information about a package scheduled for delivery at a first location. The package corresponds to a recipient at the first location. The method also includes analyzing mobility data of a neighbor at a second location. The method also based on the analysis, selecting the neighbor as an authorized recipient of the package.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device receive information about a package scheduled for delivery at a first location. The package corresponds to a recipient at the first location. The one or more instructions further cause the device to analyze mobility patterns of a plurality of neighbors at a plurality of locations. The one or more instructions further cause the device to based on the analysis, select a neighbor of the plurality of neighbors as an authorized recipient of the package scheduled for delivery at the first location. Also, a computer program product may be provided. For example, a computer program product comprising instructions which, when the program is executed by a computer, cause the computer to carry out the steps described herein.

In accordance with another aspect of the disclosure, an apparatus is provided. The apparatus includes a processor. The apparatus also includes a memory comprising computer program code for one or more programs. The computer program code is configured to cause the processor of the apparatus to receive information about a package scheduled for delivery at a first location. The package corresponds to a recipient at the first location. The computer program code is further configured to cause the processor of the apparatus to analyze mobility patterns of a plurality of neighbors at a plurality of locations. The computer program code is further configured to cause the processor of the apparatus to compare a mobility pattern of the recipient with the mobility patterns of the plurality of neighbors. The computer program code is further configured to cause the processor of the apparatus to based on the comparison, select a neighbor of the plurality of neighbors as an authorized recipient of the package scheduled for delivery at the first location.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of optimizing the delivery of a package, in accordance with aspects of the present disclosure;

FIG. 2 is a diagram illustrating an example scenario for optimizing the delivery of a package, in accordance with aspects of the present disclosure;

FIG. 3 is a diagram illustrating another example scenario for optimizing the delivery of a package, in accordance with aspects of the present disclosure;

FIG. 4 is a diagram illustrating another example scenario for optimizing the delivery of a package, in accordance with aspects of the present disclosure;

FIG. 5 is a diagram of a geographic database, in accordance with aspects of the present disclosure;

FIG. 6 is a diagram of the components of a data analysis system, in accordance with aspects of the present disclosure;

FIG. 7 is a flowchart setting forth steps of an example process, in accordance with aspects of the present disclosure;

FIG. 8 is a flowchart setting forth steps of another example process, in accordance with aspects of the present disclosure;

FIG. 9 is a flowchart setting forth steps of another example process, in accordance with aspects of the present disclosure;

FIG. 10 is a diagram of an example computer system, in accordance with aspects of the present disclosure;

FIG. 11 is a diagram of an example chip set, in accordance with aspects of the present disclosure; and

FIG. 12 is a diagram of an example mobile device, in accordance with aspects of the present disclosure.

### DESCRIPTION OF SOME EMBODIMENTS

Examples of a method, a non-transitory computer-readable storage medium, and an apparatus for optimizing the delivery of a package are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

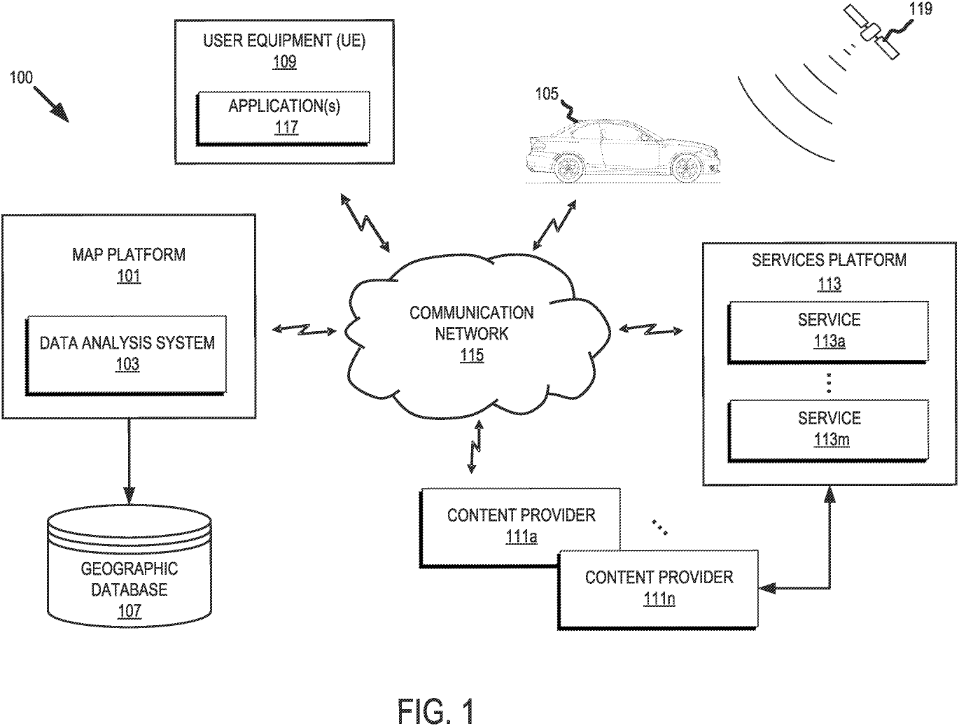

FIG. 1 is a diagram of a system 100 capable of optimizing the delivery of a package, according to one embodiment. The system 100 enables the sharing of real-time or expected availability, based on mobility patterns, between neighbors so that a neighbor can act as an authorized recipient of a package when the intended recipient is unavailable to receive the package. The system 100 can select the most suitable neighbor based on the availability of the neighbors and the intended recipient. The system 100 is capable of establishing communication between the intended recipient of a package and a temporary authorized recipient.

The system 100 of FIG. 1 introduces a capability to receiving information about a package scheduled for delivery at a first location. In one example, the package corresponds to a recipient at the first location. The system 100 can analyze the mobility data of a neighbor at a second location. In one example, the analysis of the mobility data is based on historical data. In another example, the analysis of the mobility data is based on real-time data. In one example, the neighbor is selected from one or more neighbors that the intended recipient of the package has approved to act as authorized recipients. The system 100 can, based on the analysis, select the neighbor as an authorized recipient of the package. In one example, the system 100 can provide the address of the selected neighbor to a delivery company for delivering the package to the address of the selected neighbor.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for optimizing the delivery of a package or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for optimizing the delivery of a package, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in optimizing the delivery of a package according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move packages between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for optimizing the delivery of a package. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with optimizing the delivery of a package, either alone or in combination with the data analysis system 103.

In some embodiments, the UE 109 and/or the vehicle 105 may include various sensors for acquiring a variety of different data or information. For instance, the UE 109 and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109 and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109 and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

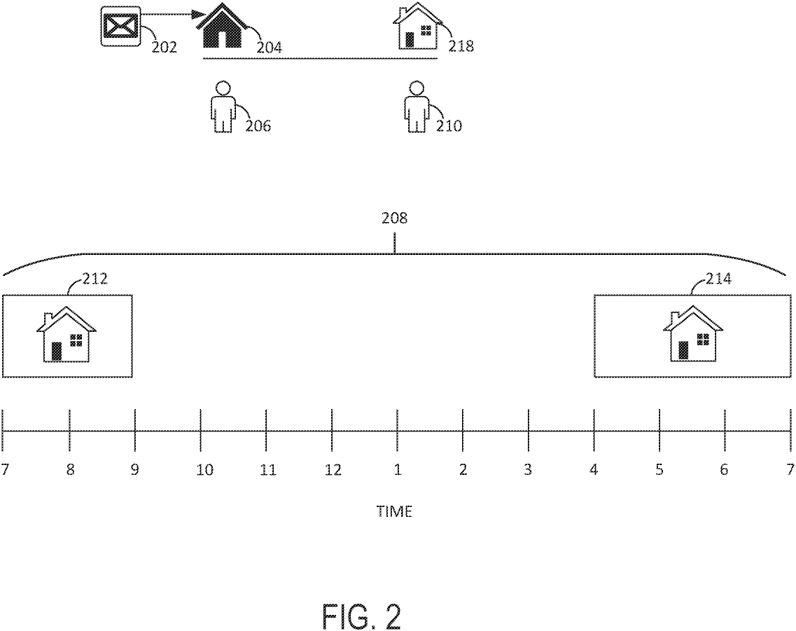

FIG. 2 is a diagram illustrating an example for optimizing the delivery of a package. The diagram includes a package 202 scheduled for delivery at a first location 204. The package 202 corresponds to a recipient 206 associated with the first location 204. The diagram includes the mobility pattern 208 of a neighbor 210 at a second location 218. The mobility pattern 208 includes mobility data 212 and 214.

In one embodiment, the system 100 of FIG. 1 is configured to receive information about a package scheduled for delivery at a first location, wherein the package corresponds to a recipient associated with the first location. In this embodiment, the system 100 is configured to analyze mobility data of a neighbor associated with a second location. Continuing with this embodiment, the system 100 is configured to, based on the analysis, select the neighbor as an authorized recipient of the package.

Information of a user location history or insights related to a user’s mobility patterns (e.g., mobility data) can be found via, for instance, location data (e.g., Global Positioning System (GPS) or equivalent data) recorded by a user device and/or a vehicle, other sensor data from user devices and/or vehicles, IP addresses of Wi-Fi access points, cell towers, and/or Bluetooth-enabled devices of other users and/or entities, private, public, and/or national surveillance systems (e.g., via cameras, satellites, internet, etc.), social media location check-in data, etc. In one embodiment, the system 100 retrieves user historical mobility data from user device sensor data, vehicle data (e.g., user historical mobility data and/or real-time information), etc., and builds a user mobility pattern model. In one instance, the system 100 of FIG. 1 can gather all user mobility data in order to generate the user mobility pattern model. By way of example, the insights may include when and where the user travels to a location, and the used mode(s) of transport (i.e., checked-out); when and where each mode of transport is released (i.e., checked-in); how long the user stays at a given location; where the user is located within the threshold proximity to a point of interest (e.g., restaurant, supermarket, park, etc.) at a given time; correlations that can be made relative to other factors such as weather, events, day of the week, etc.

In one example, the system 100 of FIG. 1 is configured to receive information about the package 202 scheduled for delivery at the first location 204. The information about the package 202 may include information about the recipient 206 (e.g., name, address, etc.), the expected delivery time of the package, the weight of the package, the delivery company assigned to the package, etc. In this example, the system 100 is configured to analyze the mobility data 212 and 214 of the neighbor 210 associated with the second location 218. The analysis of the mobility data 212 and 214 may be used to determine the likelihood of the neighbor 210 being available to act as an authorized recipient of the package 202 if the recipient 206 is unavailable to receive the package 202. Continuing with this example, the system 100 is configured to, based on the analysis, select the neighbor 210 as an authorized recipient of the package 202. In one embodiment, the analysis also includes the value of the package, the package weight, the estimated time the package will be unattended, the intended recipient’s expected time of arrival, the time of day, and other inputs. In another embodiment, more or less inputs can be included in the analysis.

In one example, the system 100 of FIG. 1 is configured to determine that the neighbor 210 is expected to be at the second location 218 between the hours of 7AM and 9AM based on an analysis of the mobility data 212. Continuing with this example, the system 100 is configured to determine that the neighbor 210 is expected to be at the second location 218 between the hours of 4 PM and 7 PM based on analysis of the mobility data 214. In one example, the information about the package 202 may indicate that the expected delivery time of the package 202 is between 4PM and 6PM. In this example, the system 100 of FIG. 1 may determine that the neighbor 210 will likely be at the second location 218 between the hours of 4PM and 7PM, based on the mobility data 214. Continuing with this example, the system 100 is configured to select the neighbor 210 as an authorized recipient of the package 202, based on the analysis of the mobility data 214. In one example, the selection of the neighbor 210 as an authorized recipient may be selected from a list of neighbors that are authorized to receive packages on behalf of the recipient 206. In one scenario, the selection of the neighbor 210 as the authorized recipient is based on an approval via an input received at the system 100 by the recipient 206. In another scenario, the selection of the neighbor 210 as an authorized recipient is based on automatic decision by the system 100 without an input from the recipient 206.

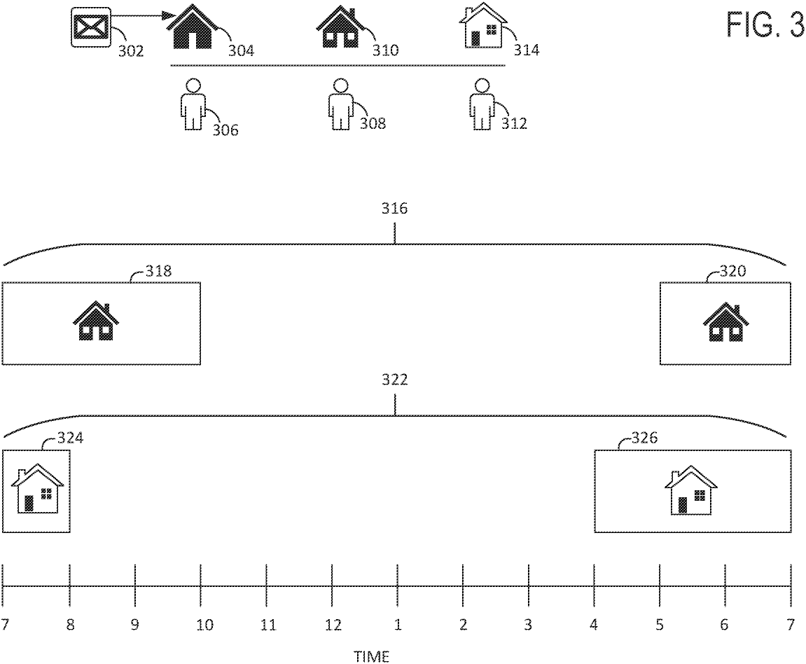

FIG. 3 is a diagram illustrating an example for optimizing the delivery of a package. The diagram includes a package 302 scheduled for delivery at a first location 304. The package 302 corresponds to a recipient 306 associated with the first location 304. The diagram includes a neighbor 308 associated with a second location 310 and a neighbor 312 associated with a third location 314. The diagram includes the mobility pattern 316 of the second neighbor 308 at the second location 310. The mobility pattern 316 includes mobility data 318 and 320. The diagram includes the mobility pattern 322 of the second neighbor 312 at the third location 314. The mobility pattern 322 includes mobility data 324 and 326.

In one embodiment, the system 100 of FIG. 1 is configured to receive information about a package scheduled for delivery to a first location, wherein the package corresponds to a recipient associated with the first location. In this embodiment, the system 100 is configured to analyze mobility patterns of a plurality of neighbors at a plurality of locations. Continuing with this embodiment, the system 100 is configured to, based on the analysis, select a neighbor of the plurality of neighbors as an authorized recipient of the package scheduled for delivery at the first location.

In one example, the system 100 of FIG. 1 is configured to receive information about the package 302 scheduled for delivery at the first location 304. The information about the package 302 may include information about the recipient 306 (e.g., name, address, etc.), the expected delivery time of the package, the weight of the package, the delivery company associated with the package, etc. In this example, the system 100 is configured to analyze the mobility data 318 and 320 of the neighbor 308 associated with the second location 310. The analysis of the mobility data 318 and 320 may be used to determine the likelihood of the neighbor 308 being available to act as an authorized recipient of the package 302 if the recipient 306 is unavailable to receive the package 302. Continuing with this example, the system 100 is configured to analyze the mobility data 324 and 326 of the neighbor 312 associated with the third location 314. The analysis of the mobility data 324 and 326 may be used to determine the likelihood of the neighbor 312 being available to act as an authorized recipient of the package 302 if the recipient 306 is unavailable to receive the package 302. Continuing with this example, the system 100 is configured to, based on the analysis, select either the neighbor 308 or the neighbor 312 as an authorized recipient of the package 302.

In one example, the system 100 of FIG. 1 is configured to analyze the mobility patterns 316 and 322 of the neighbors 308 and 312. In this example, the system 100 is configured to determine that the neighbor 308 is expected to be at the second location 310 between the hours of 7 AM and 10 AM based on an analysis of the mobility data 318. Continuing with this example, the system 100 is configured to determine that the neighbor 308 is expected to be at the second location 310 between the hours of 5 PM and 7 PM based on analysis of the mobility data 320. Continuing with this example, the system 100 is configured to determine that the neighbor 312 is expected to be at the third location 314 between the hours of 7 AM and 8 AM based on an analysis of the mobility data 324. Continuing with this example, the system 100 is configured to determine that the neighbor 312 is expected to be at the third location 314 between the hours of 4 PM and 7 PM based on an analysis of the mobility data 326.

In one example, the information about the package 302 may indicate that the expected delivery time of the package 302 is between 7 AM and 10 AM. In this example, the system 100 of FIG. 1 may determine that the neighbor 308 will likely be at the second location 310 between the hours of 7 AM and 10 AM, based on the mobility data 318. Continuing with this example, the system 100 may determine that the neighbor 312 will likely at the third location 314 between the hours of 7 AM and 8 AM, based on the mobility data 324. Continuing with this example, based on the analysis of the mobility patterns 316 and 322 of the neighbors 308 and 312, respectively, the system 100 is configured to select the neighbor 308 as an authorized recipient of the package 302 instead of the neighbor 312. In this example, the system 100 may be configured to select the neighbor 308 over the neighbor 312 based on the additional two hours (i.e., 8 M to 10 AM) that the neighbor 308 is likely to be at the second location 310 compared to when the neighbor 312 is likely to leave the third location 314 by 8 AM. The system 100 may be configured to determine that if delivery of the package 302 occurs after 8 AM, then the neighbor 312 is less likely to be available to receive the package 302 and therefore proceed to select the neighbor 308 to act as an authorized recipient of the package 302.

In another example, the information about the package 302 may indicate that the expected delivery time of the package 302 is between 5 PM and 7 PM. In this example, the system 100 of FIG. 1 may determine that the neighbor 308 will most likely be at the second location 310 between the hours of 5 PM and 7 PM, based on the mobility data 320. Continuing with this example, the system 100 may determine that the neighbor 312 is expected to be at the third location 314 between the hours of 4 PM and 7 PM. Continuing with this example, based on the analysis of the mobility patterns 316 and 322 of the neighbors 308 and 312, respectively, the system 100 is configured to select the neighbor 312 as an authorized recipient of the package 302 instead of the neighbor 308. In this example, the system 100 may be configured to select the neighbor 312 over the neighbor 308 based on the additional hour before 5 PM that the neighbor 312 is expected to be at the third location 314 compared to when the neighbor 308 is expected to arrive at the second location 310.

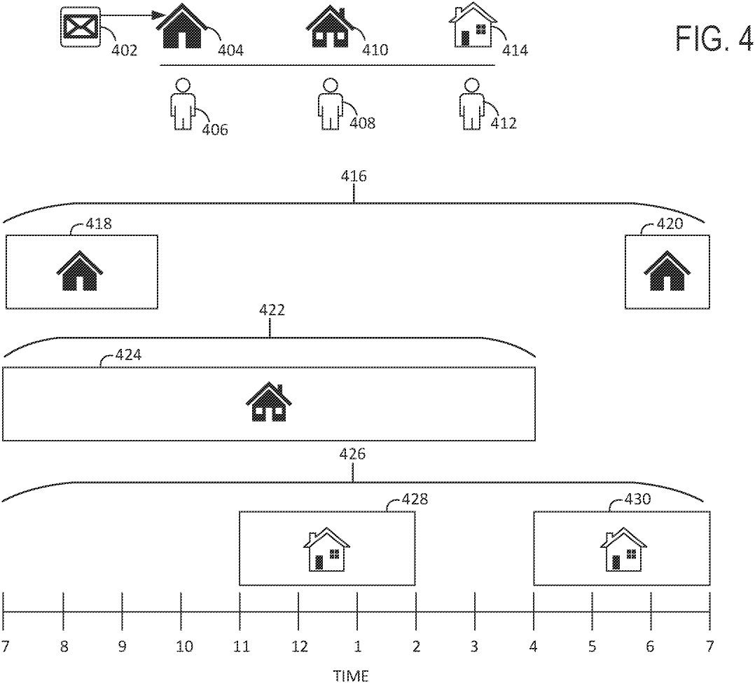

FIG. 4 is a diagram illustrating an example for optimizing the delivery of a package. The diagram includes a package 402 scheduled for delivery at a first location 404. The package 402 corresponds to a recipient 406 associated with the first location 404. The diagram includes a neighbor 408 associated with a second location 410 and a neighbor 412 associated with a third location 414. The diagram includes the mobility pattern 416 of the recipient 406 at the first location 404. The mobility pattern 416 includes mobility data 418 and 420. The diagram includes the mobility pattern 422 of the neighbor 408 at the second location 410. The mobility pattern 422 includes mobility data 424. The diagram includes the mobility pattern 426 of the neighbor 412 at the third location 414. The mobility pattern 426 includes mobility data 428 and 430.

In one embodiment, the system 100 of FIG. 1 is configured to receive information about a package scheduled for delivery to a first location, wherein the package corresponds to a recipient associated with the first location. In this embodiment, the system 100 is configured to analyze the mobility patterns of a plurality of neighbors at a plurality of locations. Continuing with this embodiment, the system 100 is configured to compare a mobility pattern of the recipient with the mobility patterns of the plurality of neighbors. In this embodiment, the system 100 is configured to, based on the comparison, select a neighbor of the plurality of neighbors as an authorized recipient of the package scheduled for delivery at the first location.

In one example, the system 100 of FIG. 1 is configured to receive information about the package 402 scheduled for delivery at the first location 404. The information about the package 402 may include information about the recipient 406 (e.g., name, address, etc.), the expected delivery time of the package, the weight of the package, the delivery company associated with the package, etc. In this example, the system 100 is configured to analyze the mobility pattern 422 of the neighbor 408 at the second location 410. The analysis of the mobility pattern 422 may include an analysis of the mobility data 424 to determine the likelihood that the neighbor 408 is available to act as an authorized recipient of the package 402 if the recipient 406 is unavailable to receive the package 402. Continuing with this example, the system 100 is configured to analyze the mobility pattern 426 of the neighbor 412 at the third location 414. The analysis of the mobility pattern 426 may include an analysis of the mobility data 428 and 430 to determine the likelihood that the neighbor 412 is available to act as an authorized recipient of the package 402 if the recipient 406 is unavailable to receive the package 402. Continuing with this example, the system 100 is configured to compare the mobility pattern 416 of the recipient 406 with the mobility patterns 422 and 426 of the neighbors 408 and 412, respectively. Continuing with this example, the system 100 is configured to, based on the comparison, select either the neighbor 408 or the neighbor 412 as an authorized recipient of the package 402.

In one example, the information about the package 402 may indicate that the expected delivery time of the package 402 is between 12 PM and 1 PM. In this example, the system 100 of FIG. 1 may be configured to determine that the neighbor 408 will likely be at the second location 410 between the hours of 7 AM and 4 PM, based on the mobility pattern 422. Continuing with this example, the system 100 may be configured to determine that the neighbor 412 will likely be at the third location 414 between the hours of 11 AM and 2 AM and between the hours of 4 PM and 7 PM, based on the mobility pattern 426. In this example, the system 100 is configured to analyze the mobility patterns 422 and 426 and determine that both neighbors 408 and 412 are available to act as an authorized recipient for the package 402. Continuing with this example, the system 100 may be configured to compare the mobility pattern 416 of the recipient 406 with the mobility patterns 422 and 426 of the neighbors 408 and 412, respectively. In this example, the system 100 is configured to determine that based on the mobility pattern 416 and the mobility pattern 426, there is a higher likelihood that the recipient 406 may be able to meet up with the neighbor 412 to retrieve the package 402 if the neighbor 412 is selected as the authorized recipient of the package 402 as opposed to the neighbor 408 being selected. Continuing with this example, the system 100 is configured to select the neighbor 412 as the authorized recipient of the package 402 scheduled for delivery at the first location 404.

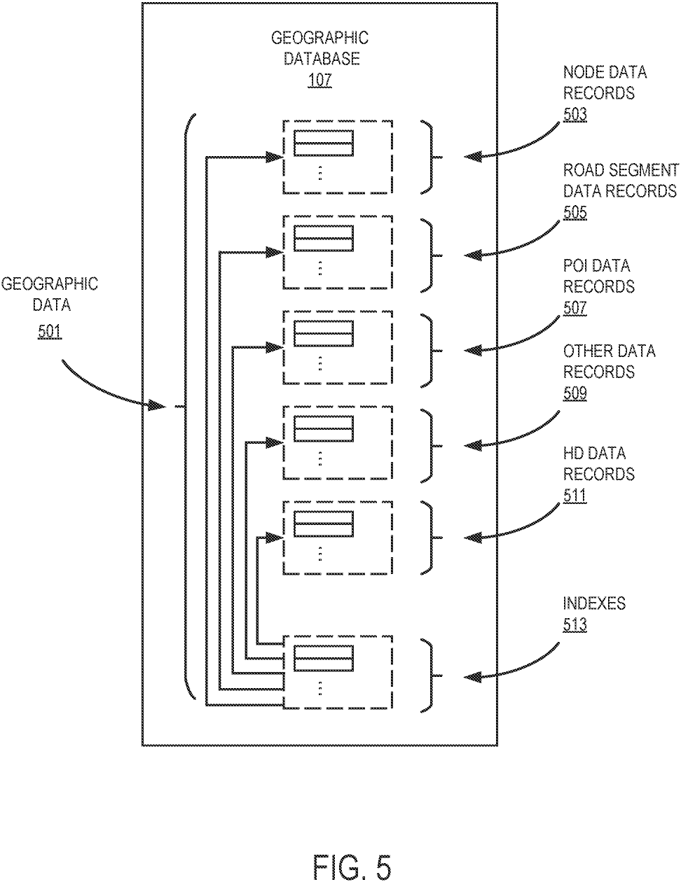

FIG. 5 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 501 used for (or configured to be compiled to be used for) mapping and/or navigation-related services, such as for personalized route determination, according to exemplary embodiments. For example, the geographic database 107 includes node data records 503, road segment data records 505, POI data records 507, other data records 509, HD data records 511, and indexes 513, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node” - A point that terminates a link.

“Line segment” - A straight line connecting two points.

“Link” (or “edge”) - A contiguous, non-branching string of one or more line segments terminating in a node at each end.

“Shape point” - A point along a link between two nodes (e.g., used to alter a shape of the link without defining new nodes).

“Oriented link” - A link that has a starting node (referred to as the “reference node”) and an ending node (referred to as the “non reference node”).

“Simple polygon” - An interior area of an outer boundary formed by a string of oriented links that begins and ends in one node. In one embodiment, a simple polygon does not cross itself.

“Polygon” - An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 505 are links or segments representing roads, streets, or paths, as can be used in the calculated route or recorded route information for determination of one or more personalized routes, according to exemplary embodiments. The node data records 503 are end points or vertices (such as intersections) corresponding to the respective links or segments of the road segment data records 505. The road segment data records 605 and the node data records 503 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 507. In one example, the POI data records 507 may include the hours of operation for various businesses. The geographic database 107 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, other data records 509 include cartographic (“carto”) data records, routing data, delivery data, weather data, and maneuver data. In one example, the other data records 509 include data that is associated with certain POIs, roads, or geographic areas. In one example, the data is stored for utilization by a third-party. In one embodiment, the other data records 509 include traffic data records such as traffic data reports. In one example, the traffic data reports are based on historical data. In another example, the traffic data reports are based on real-time traffic data reports. In one embodiment, the other data records 509 include event data. In one example, the event data includes information about upcoming events such as start time, end time, impact to access to one or more road segments, etc. In one embodiment, the other data records 509 include weather data records such as weather data reports. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example. In another embodiment, the other data records 509 include delivery data records. In one example, the delivery data records include lists of neighbors that can be selected to act as authorized recipients of packages. In another example, the delivery data records may include information about the packages (e.g., size, weight, dates, times, etc.) and the various neighbors that have been selected to act as authorized recipients for packages. In another example, the delivery data records may include the mobility patterns of neighbors that can be selected to act as authorized recipients of packages.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 503, road segment data records 505, and/or POI data records 507 to support verification, localization or visual odometry based on the features stored therein and the corresponding estimated quality of the features. In this way, the point data records can also be associated with or used to classify the characteristics or metadata of the corresponding records 503, 505, and/or 507.

As discussed above, the HD data records 511 may include models of road surfaces and other map features to centimeter-level or better accuracy. The HD data records 511 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 511 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 511 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 511.

In one embodiment, the HD data records 511 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 513 in FIG. 5 may be used improve the speed of data retrieval operations in the geographic database 107. Specifically, the indexes 513 may be used to quickly locate data without having to search every row in the geographic database 107 every time it is accessed. For example, in one embodiment, the indexes 513 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

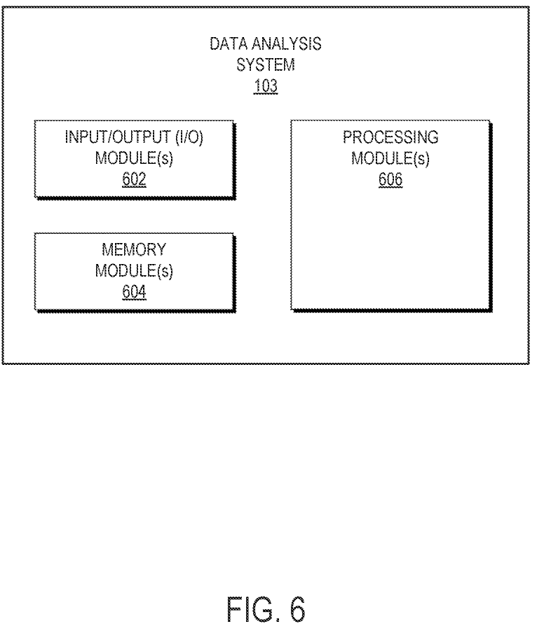

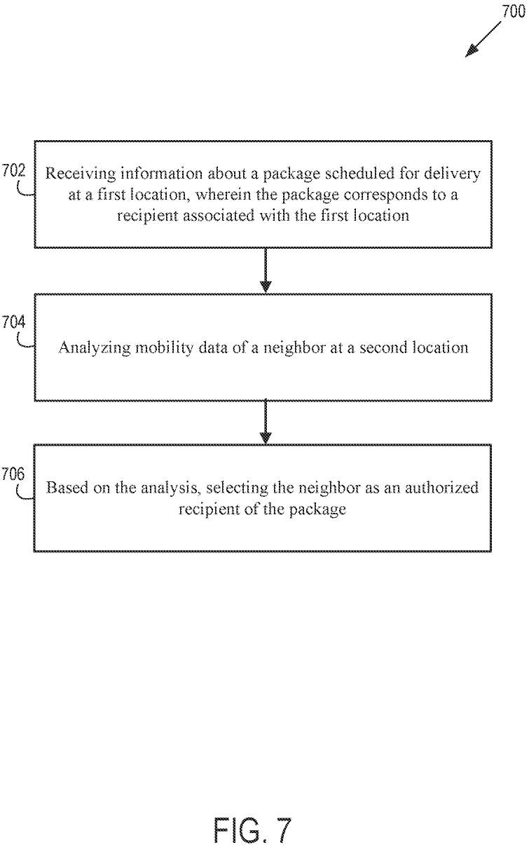

FIG. 6 is a diagram of the components of the data analysis system 103 of FIG. 1, according to one embodiment. By way of example, the data analysis system 103 includes one or more components for optimizing the delivery of a package according to the various embodiments described herein. It is contemplated that the functions of these components may be combined or performed by other components of equivalent functionality. In this embodiment, data analysis system 103 includes in input/output module 602, a memory module 604, and a processing module 606. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 602-606 may be implemented as a cloud-based service, local service, native application, or combination thereof. The functions of these modules are discussed with respect to FIGS. 7, 8, and 9 below.

FIGS. 7, 8, and 9 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 7, 8, and 9 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 7, 8, and 9 may represent circuitry that is wired to perform the specific logical functions in the process. Illustrative methods, such as those shown in FIGS. 7, 8, and 9, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 7, 8, and 9 may be fully performed by a computing device (or components of a computing device such as one or more processors) or may be distributed across multiple components of the computing device, across multiple computing devices, and/or across a server.

Referring first to FIG. 7, an example method 700 may include one or more operations, functions, or actions as illustrated by blocks 702-706. The blocks 702-706 may be repeated periodically or performed intermittently, or as prompted by a user, device, or system. In one embodiment, the method 700 is implemented in whole or in part by the data analysis system 103 of FIG. 6.

As shown by block 702, the method 700 includes receiving information about a package scheduled for delivery at a first location, wherein the package corresponds to a recipient associated with the first location. In one example, the processing module 606 of FIG. 6 is configured to receive, via the input/output module 602 of FIG. 6, information about a package scheduled for delivery at a first location. In one example, the information about the package includes the recipient address, an authorized neighbor’s address, weight, and the tracking number(s). In one example, the information about the package scheduled for delivery at the first location is stored in the memory module 604 of FIG. 6.

In one example, the mobility data is based on the detection of a mobile device (e.g., UE 109 of FIG. 1) within the second location. In one example, the processing module 606 of FIG. 6 is configured to determine the presence of a neighbor at the second location using GPS. In one example, a geofence is a defined set of GPS coordinates indicating the bounds of a neighbor’s home. In one embodiment, the processing module 606 is configured to detects the GPS coordinates of a mobile device associated with the neighbor and determines whether or not they are within the geofence. If the GPS coordinates are within the geofence, then the neighbor’s status is ‘Available’. If the GPS coordinates are outside geofence, then the neighbor’s status is ‘Unavailable’.

In one example, a neighbor is determined according to the location of a home within a neighborhood. In one example, the neighborhood may be a residential area, a commercial area, a rural area, and/or a mixed-use area, among other examples. In addition, the homes may be any type of structures, and the structures need not be located next to one another, but rather may be located in different geographic locations separated by any predetermined distance (e.g., same subdivision, same commercial block, same multi-unit building, different sub-divisions, different commercial blocks, located on the same street but separated by one or more miles).

In one example, the second location is within a predetermined distance of the first location. In one scenario, the processing module 606 of FIG. 6 is configured to receive, via the input/output module 602 of FIG. 6, the predetermined distance based on one or more inputs from an individual associated with the first location. In one example, the predetermined distance is based on historical delivery data. In one example, the historical delivery data includes one or more designated locations by an individual associated with the first location. For example, the individual may designate one or more neighbors for packages over a certain size and/or weight.

In one example, as shown by block 704, the method 700 also includes analyzing the mobility data of the neighbor at the second location by comparing the mobility data of the recipient with the mobility data of the neighbor. In one example, the method 700 also includes based on the comparison of the mobility data of the recipient with the mobility data of the neighbor, determining a time for meeting between the recipient and the neighbor. In another example, the method 700 also includes, based on the comparison of the mobility data of the recipient with the mobility data of the neighbor, determining a location for meeting between the recipient and the neighbor. In one example, the processing module 606 of FIG. 6 is configured to compare the mobility data of the recipient with the mobility data of the neighbor and determine a time and/or location for meeting between the recipient and the neighbor.

In one embodiment, the method 700 also includes receiving an input for specifying a designated time frame for meeting between the recipient and the neighbor. In this embodiment, the method 700 also includes providing a notification to the neighbor or the recipient that includes the designated time frame for meeting. In one example, the processing module 606 of FIG. 6 is configured to receive an input for specifying a designated time frame for meeting between the recipient and the neighbor via the input/output module 602 of FIG. 6. In this example, the processing module 606 is configured to provide a notification to the neighbor or the recipient that includes the designated time frame for meeting via the input/output module 602. In one example, the input is received via a user-interface that is part of an application (e.g., application(s) 117 of FIG. 1) on a portable electronic device (e.g., UE 109 of FIG. 1).

In another embodiment, the method 700 also includes receiving an input for specifying a designated location for meeting the neighbor. In this embodiment, the method 700 also includes providing a notification to the neighbor or the recipient that includes the designated location for meeting. In one example, the processing module 606 of FIG. 6 is configured to receive an input for specifying a designated location for meeting the neighbor via the input/output module 602 of FIG. 6. In this example, the processing module 606 of FIG. 6 is configured to provide a notification to the neighbor or the recipient that includes the designated location for meeting via the input/output module 602.

As shown by block 706, the method 700 also includes based on the analysis, selecting the neighbor as an authorized recipient of the package. In one example, the processing module 606 of FIG. 6 is configured to, based on the analysis, select the neighbor as an authorized recipient of the package. In one example, the neighbor is selected as the authorized recipient of the package based on a likelihood that the neighbor will be available at the second location based on mobility data. In another example, the neighbor is selected as the authorized recipient of the package based on one or more inputs from the recipient associate with the first location. For example, the recipient may approve or deny the selected neighbor as the authorized recipient of the package prior to sending a notification to the selected neighbor. In one example, the processing module 606 is configured to provide the neighbor’s address for delivery of the package at the selected neighbor’s address via the input/output module 602 of FIG. 6.

In one embodiment, the method 700 also includes providing a notification to the neighbor that includes the information about the package scheduled for delivery at the first location. In one example, the processing module 606 of FIG. 6 is configured to provide a notification to the neighbor that includes information about the package scheduled for delivery at the first location via the input/output module 602 of FIG. 6. In one example, the notification is a message that an individual can receive on an electronic device in real-time. For example, the notification may be a push notification, a short message service (SMS) message, a multimedia messaging service (MMS) message, and other messages.

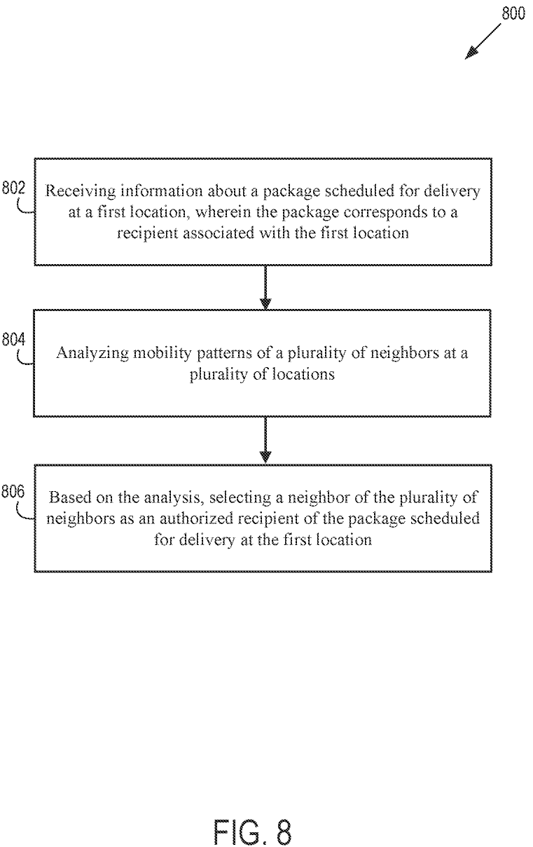

Referring to FIG. 8, the example method 800 may include one or more operations, functions, or actions as illustrated by blocks 802-806. The blocks 802-806 may be repeated periodically or performed intermittently, or as prompted by a user, device, or system. In one embodiment, the method 800 is implemented in whole or in part by the data analysis system 103 of FIG. 6.

As shown by block 802, the method 800 includes receiving information about a package scheduled for delivery at a first location, wherein the package corresponds to a recipient associated with the first location. In one example, the processing module 606 of FIG. 6 is configured to receive, via the input/output module 602 of FIG. 6, information about a package scheduled for delivery at a first location, wherein the package corresponds to a recipient associated with the first location. Block 802 may be similar in functionality to block 702 of method 700.

As shown by block 804, the method 800 also includes analyzing mobility patterns of a plurality of neighbors at a plurality of locations. In one example, the processing module 606 of FIG. 6 is configured to analyze mobility patterns of a plurality of neighbors at a plurality of locations. In one example, the plurality of locations are within a predetermined distance of the first location. In one example, the mobility pattern includes an individual mobility pattern, a vehicle mobility pattern, or a combination thereof under one or more contexts for travel to or from a plurality of locations. In another example, the processing module 606 is configured to analyze the mobility patterns with respect to a vehicle type (e.g., a bus, a car, a bicycle, a scooter), a vehicle operator (e.g., Company A, Company B, Company C, etc.), or a combination thereof. In one example, the mobility patterns may be based on historical mobility data or real-time mobility data.

In one embodiment, the method 800 also includes comparing a mobility pattern of the recipient with the mobility patterns of the plurality of neighbors. In this embodiment, the method 800 also includes based on the comparison, ranking the mobility patterns of the plurality of neighbors. In one example, the processing module 606 of FIG. 6 is configured compare a mobility pattern of the recipient with the mobility patterns of the plurality of neighbors. In this example, the processing module 606 is configured to, based on the comparison, rank the mobility patterns of the plurality of neighbors.

In one embodiment, the processing module 606 is configured to rank the mobility patterns of the plurality of neighbors based at least in part on the times of departure from the plurality of locations compared to when the recipient is expected to be at the first location (i.e., home). For example, if a package is scheduled for delivery at 11 AM and the recipient will be home from 3 PM to 6 PM, the mobility pattern of a first neighbor that indicates an availability from 9 AM to 2 PM will be ranked lower than the mobility pattern of a second neighbor that indicates an availability from 10 AM to 4 PM. In this example, both neighbors are available to act as authorized recipient of the package. However, the recipient has a higher likelihood of obtaining the package from the second neighbor compared to the first neighbor based on the overlap between the recipient’s mobility pattern and the second neighbor’s mobility pattern.

As shown by block 806, the method 800 also includes based on the comparison, selecting a neighbor of the plurality of neighbors as an authorized recipient of the package scheduled for delivery at the first location. In one example, the processing module 606 of FIG. 6 is configured to, based on the comparison, select a neighbor of the plurality of neighbors as an authorized recipient of the package scheduled for delivery at the first location. In one example, the processing module 606 is configured to provide the selected neighbor’s address for delivery of the package at the neighbor’s address via the input/output module 602 of FIG. 6.

In one embodiment, the method 800 also includes providing a notification to the neighbor that includes the information about the package scheduled for delivery at the first location. In one example, the processing module 606 of FIG. 6 is configured to provide, via the input/output module 602 of FIG. 6, a notification to the neighbor that includes the information about the package scheduled for delivery at the first location.

In one embodiment, the method 800 also includes determining a time for meeting between the recipient and the selected neighbor. In one example, the processing module 606 of FIG. 6 is configured to determine a time for meeting between the recipient and the selected neighbor. In one example, the time for meeting between the recipient and the selected neighbor is based on when both individuals are located at their respective homes. In one example, the selected neighbor may provide one or more time periods of availability for meeting with the recipient via an input received at the input/output module 602 of FIG. 6.

In one embodiment, the method 800 also includes determining a location for meeting between the recipient and the selected neighbor. In one example, the processing module 606 of FIG. 6 is configured to determine a location for meeting between the recipient and the selected neighbor. In one example, the processing module 606 is configured to determine a location away from the homes of the recipient and the selected neighbor based on their respective mobility patterns. For example, the processing module 606 may be configured to determine an optimal location for meeting based on one or more frequently visited locations (e.g., an office, a restaurant, a store, etc.) by the recipient and the selected neighbor.

In one embodiment, the method 800 also includes receiving an input for specifying a designated time frame for meeting the neighbor. In this embodiment, the method 800 also includes providing a notification to the neighbor or the recipient that includes the designated time frame for meeting. In one example, the processing module 606 of FIG. 6 is configured to receive, via the input/output module 602 of FIG. 6, an input for specifying a designated time frame for meeting the neighbor. In this example, the processing module 606 is configured to provide, via the input/output module 602, a notification to the neighbor or the recipient that includes that designated time for meeting.

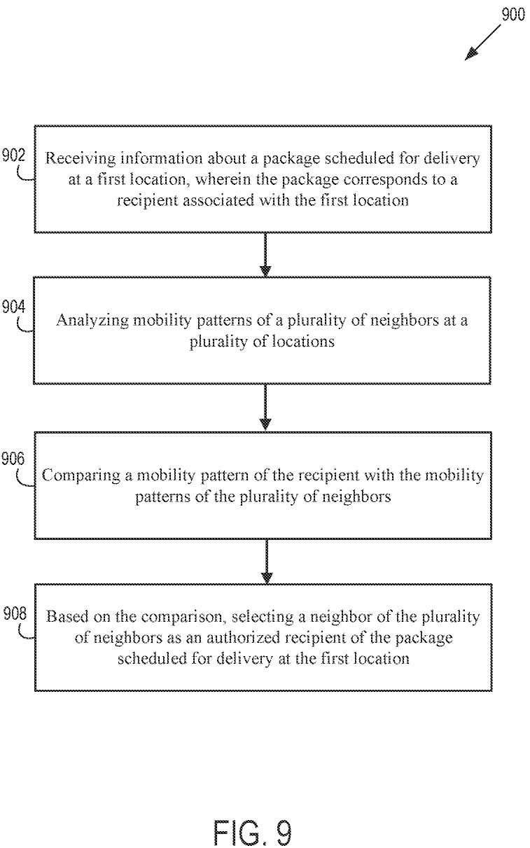

Referring to FIG. 9, the example method 900 may include one or more operations, functions, or actions as illustrated by blocks 902-908. The blocks 902-908 may be repeated periodically or performed intermittently, or as prompted by a user, device, or system. In one embodiment, the method 900 is implemented in whole or in part by the data analysis system 103 of FIG. 6.

As shown by block 902, the method 900 includes receiving information about a package scheduled for delivery at a first location, wherein the package corresponds to a recipient associated with the first location. In one example, the processing module 606 of FIG. 6 is configured to receive information about a package scheduled for delivery at a first location, wherein the package corresponds to a recipient associated with the first location. In another example, the information about the package scheduled for delivery at the first location at the location includes instructions for delivery of the package. For example, the instructions may include a list of authorized recipients of the package that are located at different locations. In one example, the information about the package scheduled for delivery at the first location and the list of authorized recipients is stored in the memory module 604 of FIG. 6.

As shown by block 904, the method 900 also includes analyzing mobility patterns of a plurality of neighbors at a plurality of locations. In one example, the processing module 606 of FIG. 6 is configured to analyze mobility patterns of a plurality of neighbors at a plurality of locations. In one example, the plurality of neighbors at the plurality of locations are selected based on an input from the recipient associated with the first location. In one example, one or more of the plurality of neighbors may be selected by the recipient associated with the first location based on one or more routes utilized by the one or more neighbors. For example, if an individual is known to travel nearby the first location on daily basis, then the recipient at the first location may designate that individual as one of the plurality of neighbors regardless of the distance between the individual’s home and the recipient’s home. In another example, the plurality of locations are within a predetermined distance of the first location. Block 904 may be similar in functionality to block 804 of method 800.

As shown by block 906, the method 900 also includes comparing a mobility pattern of the recipient with the mobility patterns of the plurality of neighbors. In one example, the processing module 606 of FIG. 6 is configured to compare a mobility pattern of the recipient with the mobility patterns of the plurality of neighbors. In one example, the processing module 606 of FIG. 6, based on the comparison, is configured to determine when a package can be picked up by the recipient from the plurality of neighbors. For example, the processing module 606 may be configured to determine that two neighbors are available to receive the package but only one of them will be available at a later point in time to provide the package to the recipient. In this example, the processing module 606 may be configured to assign a higher weight to the neighbor that is available at the later point in time to provide the package to the recipient.

As shown by block 908, the method 900 also includes based on the comparison, selecting a neighbor of the plurality of neighbors as an authorized recipient of the package scheduled for delivery at the first location. In one example, the processing module 606 of FIG. 6 is configured to, based on the comparison, selecting a neighbor of the plurality of neighbors as an authorized recipient of the package scheduled for delivery at the first location. In one example, the memory module 604 of FIG. 6 is configured to store information about the package scheduled for delivery at the first location and the selected neighbor for further processing. In one example, the processing module 606 is configured to provide the neighbor’s address for delivery of the package at the neighbor’s address via the input/output module 602 of FIG. 6.

In one embodiment, the method 900 also includes providing a notification to the neighbor, wherein the notification includes the information about the package scheduled for delivery at the first location. In one example, the processing module 606 of FIG. 6 is configured to, via the input/output module 602 of FIG. 6, provide a notification to the neighbor, wherein the notification includes the information about the package scheduled for delivery at the first location. In one example, the notification is sent to the neighbor prior to the arrival of the package at the first location. In another example, the notification is sent to the neighbor after the arrival of the package at the first location.

In one embodiment, the method 900 also includes determining a time for meeting between the recipient and the selected neighbor. In one example, the processing module 606 of FIG. 6 is configured to determine a time for meeting between the recipient and the selected neighbor. In one example, the time for meeting between the recipient and the selected neighbor is based on one or more inputs received by the recipient and the selected neighbor. For example, the processing module 606 may be configured to determine an optimal time for meeting between the recipient and the selected neighbor based on one or more inputs received via the input/output module 602 of FIG. 6.

In one embodiment, the method 900 also includes determining a location for meeting between the recipient and the selected neighbor. In one example, the processing module 606 of FIG. 6 is configured to determine a location for meeting between the recipient and the selected neighbor. In one example, the location for meeting between the recipient and the selected neighbor is based on one or more inputs received by the recipient and the selected neighbor. For example, the processing module 606 may be configured to determine an optimal location for meeting between the recipient and the selected neighbor based on one or more inputs received via the input/output module 602 of FIG. 6.

The processes described herein for optimizing the delivery of a package may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

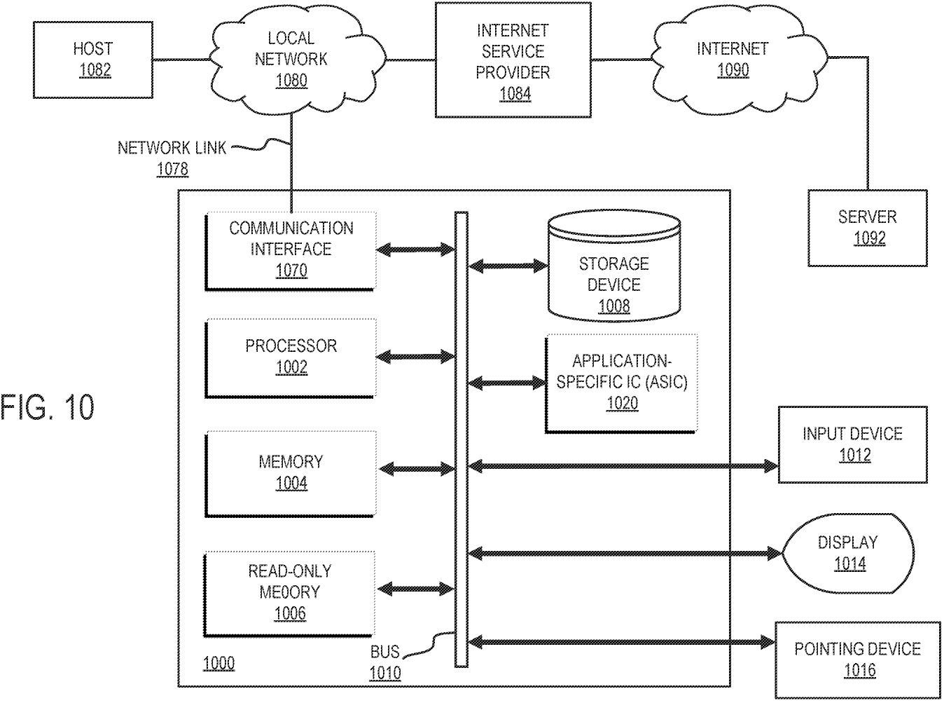

FIG. 10 illustrates a computer system 1000 upon which an embodiment may be implemented. Computer system 1000 is programmed (e.g., via computer program code or instructions) to provide information for d optimizing the delivery of a package as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to optimizing the delivery of a package. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random-access memory (RAM) or other dynamic storage device, stores information including processor instructions for optimizing the delivery of a package. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for optimizing the delivery of a package, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in the computer system 1000. Other external devices coupled to bus 1010, used primarily for interacting with humans, include a display 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1000 may also include one or more instances of a communications interface 1070 coupled to bus 1010. The communication interface 1070 may provide a one-way or two-way communication coupling to a variety of external devices that operate with their own processors, such as printers, scanners and external disks. In addition, the communication interface 1070 may provide a coupling to a local network 1080, by way of a network link 1078. The local network 1080 may provide access to a variety of external devices and systems, each having their own processors and other hardware. For example, the local network 1080 may provide access to a host 1082, or an internet service provider 1084, or both, as shown in FIG. 10. The internet service provider 1084 may then provide access to the Internet 1090, in communication with various other servers 1092.

The computer system 1000 also includes one or more instances of a communication interface 1070 coupled to bus 1010. Communication interface 1070 provides a one-way or two-way communication coupling to a variety of external devices that operate with their own processors, such as printers, scanners and external disks. In general, the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, the communication interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, the communication interface 1070 may be a local area network (LAN) card to provide a data communication connection to a compatible LAN, such as Ethernet. Wireless links may also be implemented. For wireless links, the communication interface 1070 sends or receives or both sends and receives electrical, acoustic or electromagnetic signals, including infrared and optical signals, that carry information streams, such as digital data. For example, in wireless handheld devices, such as mobile telephones like cell phones, the communication interface 1070 includes a radio band electromagnetic transmitter and receiver called a radio transceiver. In certain embodiments, the communication interface 1070 enables connection to the communication network 115 of FIG. 1 for providing information for optimizing the delivery of a package.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

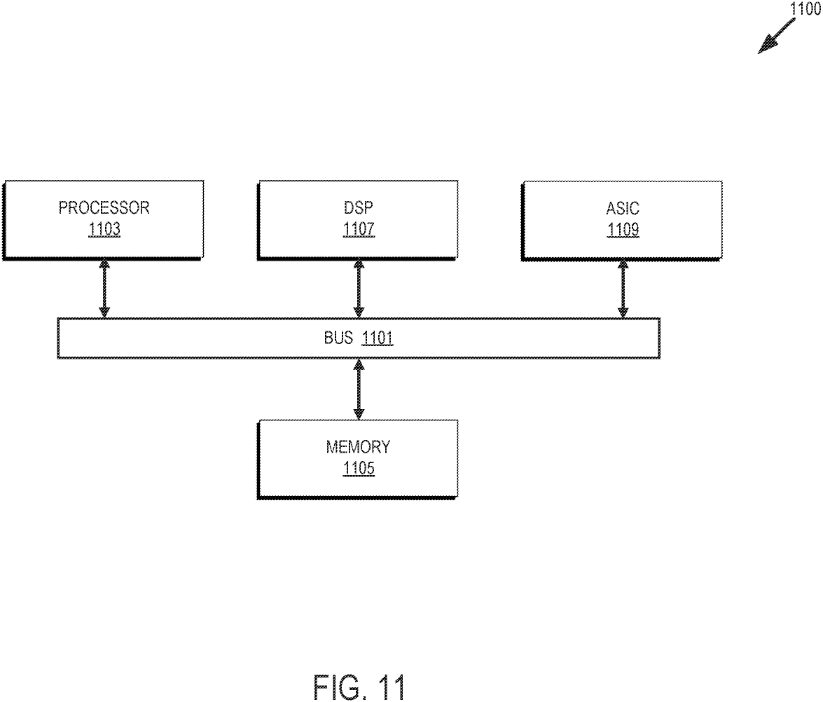

FIG. 11 illustrates a chip set 1100 upon which an embodiment may be implemented. The chip set 1100 is programmed to optimize the delivery of a package as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the steps described herein to provide information for optimizing the delivery of a package. The memory 1105 also stores the data associated with or generated by the execution of the inventive steps.

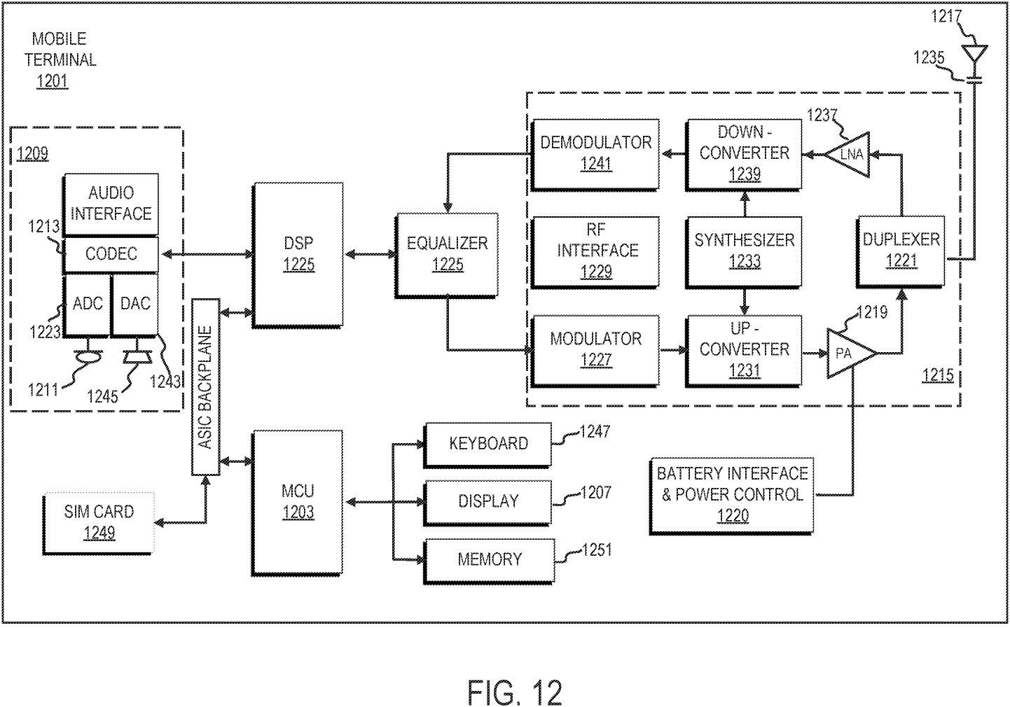

FIG. 12 is a diagram of exemplary components of a mobile terminal 1201 (e.g., a mobile device, vehicle, drone, and/or part thereof) capable of operating in the system 100 of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203-which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to provide information for d optimizing the delivery of a package. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The SIM card 1249 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We I claim:

1. A method for optimizing the delivery of a package, the method comprising:
receiving information about a package scheduled for delivery at a first location, wherein the package corresponds to a recipient associated with the first location;
analyzing mobility data of a neighbor at a second location; and
based on the analysis, selecting the neighbor as an authorized recipient of the package.

2. The method of claim 1, wherein the second location is within a predetermined distance of the first location.

3. The method of claim 1, the method further comprising:
providing a notification to the neighbor that includes the information about the package scheduled for delivery at the first location.

4. The method of claim 1, wherein analyzing the mobility data of the neighbor at the second location includes comparing mobility data of the recipient with the mobility data of the neighbor.

5. The method of claim 4, the method further comprising:
based on the comparison of the mobility data of the recipient with the mobility data of the neighbor, determining a time for meeting between the recipient and the neighbor.

6. The method of claim 4, the method further comprising:
based on the comparison of the mobility data of the recipient with the mobility data of the neighbor, determining a location for meeting between the recipient and the neighbor.

7. The method of claim 1, the method further comprising:
receiving an input for specifying a designated time frame for meeting between the recipient and the neighbor; and
providing a notification to the neighbor or the recipient that includes the designated time frame for meeting.

8. The method of claim 1, the method further comprising:
receiving an input for specifying a designated location for meeting the neighbor; and
providing a notification to the neighbor or the recipient that includes the designated location for meeting.

9. A non-transitory computer-readable storage medium comprising one or more sequences of one or more instructions for execution by one or more processors of a device, the one or more instructions which, when executed by the one or more processors, cause the device to:
receive information about a package scheduled for delivery at a first location, wherein the package corresponds to a recipient associated with the first location;
analyze mobility patterns of a plurality of neighbors at a plurality of locations;
based on the analysis, select a neighbor of the plurality of neighbors as an authorized recipient of the package scheduled for delivery at the first location.

10. The non-transitory computer-readable storage medium of claim 9, wherein the plurality of locations are within a predetermined distance of the first location.

11. The non-transitory computer-readable storage medium of claim 9, wherein the one or more instructions which, when executed by the one or more processors, further cause the device to:
provide a notification to the neighbor that includes the information about the package scheduled for delivery at the first location.

12. The non-transitory computer-readable storage medium of claim 9, wherein the computer program code is configured to cause the processor of the apparatus to analyze the mobility patterns of the plurality of neighbors at the plurality of locations is further configured to cause the processor of the apparatus to:
compare a mobility pattern of the recipient with the mobility patterns of the plurality of neighbors; and
based on the comparison, rank the mobility patterns of the plurality of neighbors.

13. The non-transitory computer-readable storage medium of claim 9, wherein the one or more instructions which, when executed by the one or more processors, further cause the device to determine a time for meeting between the recipient and the selected neighbor.

14. The non-transitory computer-readable storage medium of claim 9, wherein the one or more instructions which, when executed by the one or more processors, further cause the device to determine a location for meeting between the recipient and the selected neighbor.

15. The non-transitory computer-readable storage medium of claim 9, wherein the one or more instructions which, when executed by the one or more processors, further cause the device to:
receive an input for specifying a designated time frame for meeting the neighbor; and
provide a notification to the neighbor or the recipient that includes the designated time frame for meeting.

16. An apparatus comprising:
a processor; and
a memory comprising computer program code for one or more programs, wherein the computer program code is configured to cause the processor of the apparatus to:
receive information about a package scheduled for delivery at a first location, wherein the package corresponds to a recipient associated with the first location;
analyze mobility patterns of a plurality of neighbors at a plurality of locations;
compare a mobility pattern of the recipient with the mobility patterns of the plurality of neighbors; and
based on the comparison, select a neighbor of the plurality of neighbors as an authorized recipient of the package scheduled for delivery at the first location.

17. The apparatus of claim 16, wherein the plurality of locations are within a predetermined distance of the first location.

18. The apparatus of claim 16, wherein the computer program code is further configured to cause the processor of the apparatus to provide a notification to the neighbor, wherein the notification includes the information about the package scheduled for delivery at the first location.

19. The apparatus of claim 16, wherein the computer program code is further configured to cause the processor of the apparatus to determine a time for meeting between the recipient and the selected neighbor.

20. The apparatus of claim 16, wherein the computer program code is further configured to cause the processor of the apparatus to determine a location for meeting between the recipient and the selected neighbor.
